(19) United States
(12) Patent Application Publication
(10) Pub. No.: US 2025/0124482 A1
(43) Pub. Date: Apr. 17, 2025

(54) CONVERSION PROSPECTING FOR DYNAMIC CONTENT RECOMMENDATION

(71) Applicant: Yahoo Ad Tech LLC., New York, NY (US)

(72) Inventors: Eliran Abutbul, Kiryat Ata (IL); Yohay Kaplan, Haifa (IL); Naama Haramaty-Krasne, Kfar-Yehoshua (IL); Omer Duvdevany, Tel-Aviv (IL); Oren S. Somekh, Kfar-Netter (IL); Or David, Tel-Aviv (IL)

(21) Appl. No.: 18/380,180

(22) Filed: Oct. 15, 2023

(51) Int. Cl. G06Q 30/0601; G06Q 30/0201; G06Q 30/08

(52) U.S. Cl. CPC G06Q 30/0631; G06Q 30/0201; G06Q 30/08

(57) ABSTRACT

One or more systems and/or methods for providing conversion prospecting for dynamic content recommendation are provided. A model is trained, using positive events and negative events, to predict conversion-given-click probabilities of users and products. The model is utilized to generate a prediction of a conversion-given-click probability that a user will perform an action in relation to a product. The model is used to generate a bid for the user and the product based upon the conversion-given-click probability, a content provider bid for the product, and a target cost per action. The bid is used to determine whether the product is to compete in an auction hosted by a content serving platform that selects and transmits content items of products to devices for display to users.

### BACKGROUND

A content serving platform provides an architecture through which content items of content providers can be provided to computing devices of users. The content items may relate to products such as consumer goods (e.g., lawn mowers, smart speakers, cars, movies, etc.), services (e.g., a lawn care service, a plumbing service, a vacation planning service, a streaming service, etc.), locations, and/or a variety of other types of products. The content items may represent or describe the products through text, images, videos, social network feed posts, etc. (e.g., a photo and description of a pair of shoes, along with a link to view/purchase the shoes from a merchant). The content items may be displayed through websites, applications, emails, social network feeds, text messages, etc. In this way, the content serving platform can select or dynamically generate a content item that may be relevant to a user (e.g., a photo and description of running shoes for a user training for a marathon), and provides the content item to a computing device of the user for display.

### SUMMARY

In accordance with the present disclosure, one or more computing devices and/or methods for providing conversion prospecting for dynamic content recommendation are provided. A content serving platform utilizes various models to select content items to provide to users, such as text, images, and/or videos relating to products such as consumer goods, services, and/or other types of products. In order to improve operation of the content serving platform, such as to more accurately and precisely select content items that will be of interest to users, a model is generated and trained to predict conversion-given-click probabilities of users and products. A conversion-given-click probability may relate to the probability that a user who has clicked on a content item will then perform an action such as purchasing a product recommended by the content item. As part of training the model, the model is incrementally trained on sets of positive events (e.g., a user performing the action, such as purchasing a product, after clicking on a content item recommending the product) and negative events (e.g., a user clicking the content item, but not performing the action).

After training, the model may be utilized to predict a conversion-given-click probability that a user will perform an action related to a product. The model is used to generate a bid for the user and the product. The bid is generated based upon the conversion-given-click probability, a content provider bid for the product, and/or a target cost per action. The bid is used to determine whether the product is to compete in an auction hosted by a content serving platform. In this way, the content serving platform selects and transmits content items of products to devices for display to users.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for providing conversion prospecting for dynamic content recommendation.

FIG. 5A is a component block diagram illustrating an example system for providing conversion prospecting for dynamic content recommendation.

FIG. 5B is a component block diagram illustrating an example system including a model for providing conversion prospecting for dynamic content recommendation.

FIG. 6 is a component block diagram illustrating an example system for providing conversion prospecting for dynamic content recommendation.

FIG. 7 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

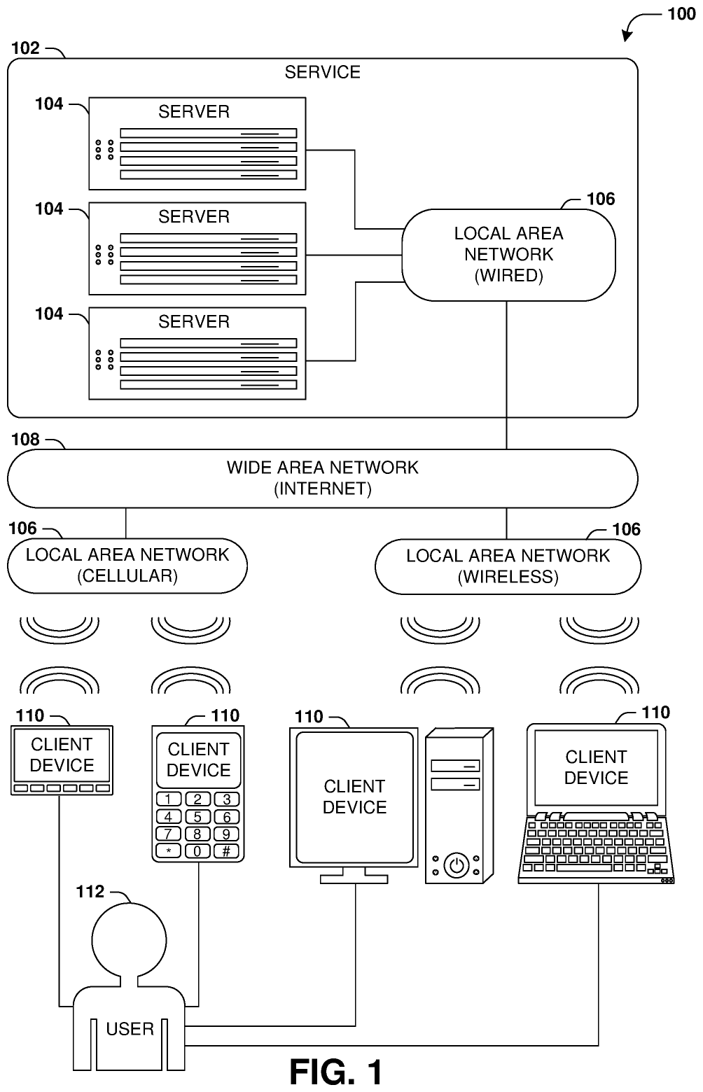

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ different architectures, may be compliant or compatible with differing protocols and/or may interoperate within the local area network 106. Additionally, a variety of local area networks 106 may be interconnected; e.g., a router may provide a link between otherwise separate and independent local area networks 106.

In scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

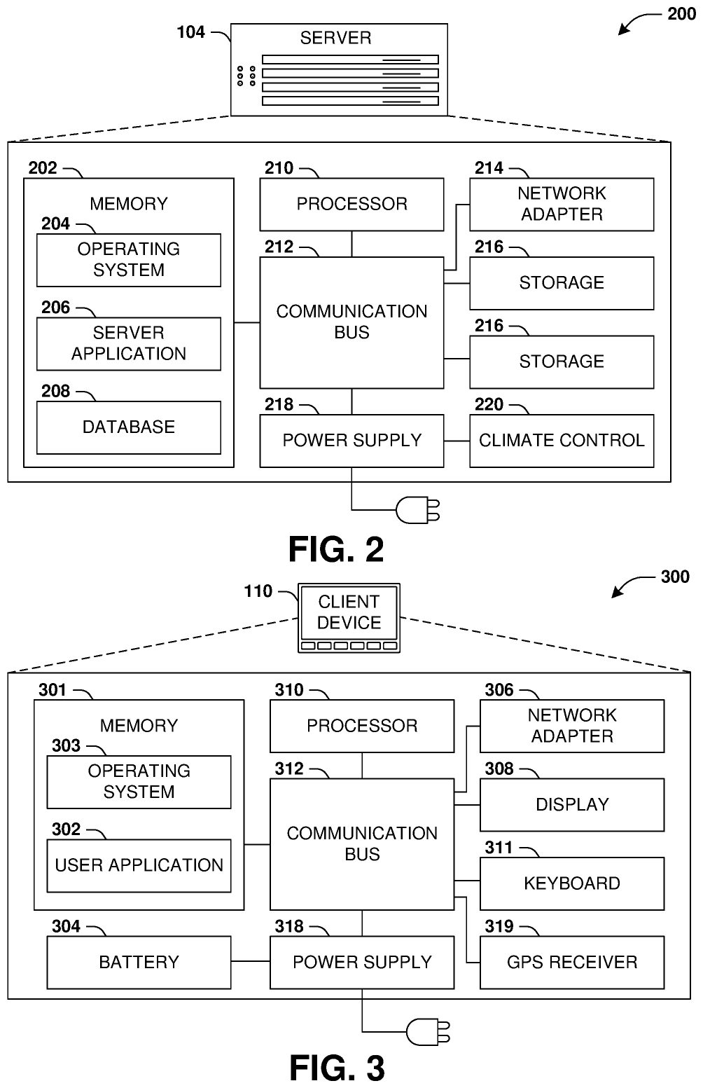

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic architecture diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

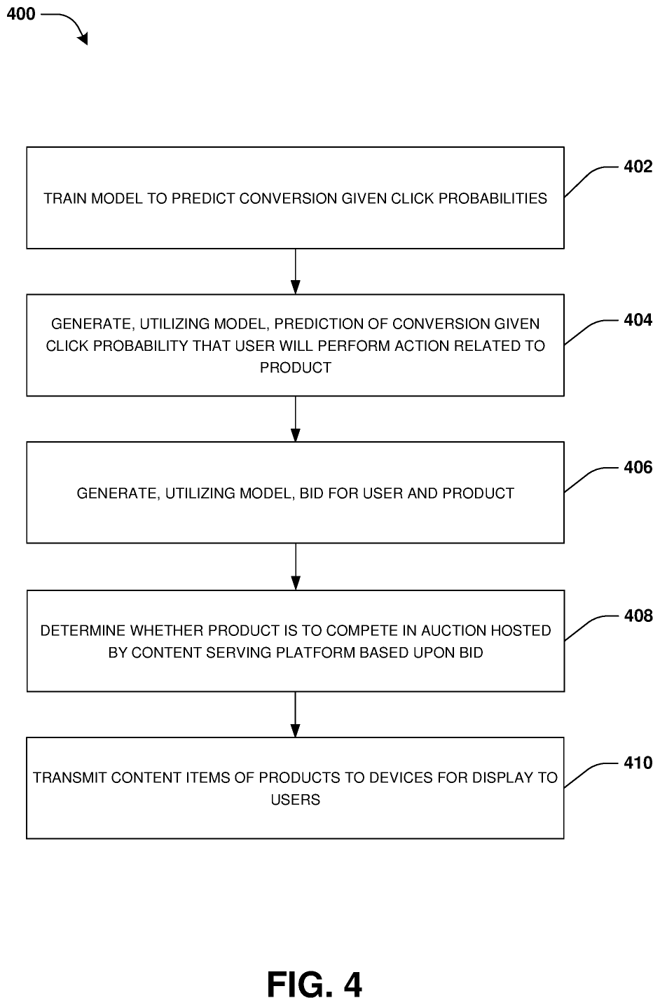

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

### 2. Presented Techniques

One or more systems and/or techniques for providing conversion prospecting for dynamic content recommendation are provided. A content serving platform serves users with content items, which may be displayed through websites (e.g., a content item constructed to resemble surrounding webpage content), applications, emails, text messages, notifications, social network feeds, and/or other user interfaces displayed on computing devices. The content items may correspond to products such as merchandise, services, and/or other types of products associated with content providers (e.g., laptops and tablets sold by an electronic company, lawn equipment sold by a lawn equipment manufacturer, music and movie streaming services of a streaming service provider, etc.). At any given time, there may be hundreds of thousands of content items available to display to users.

The content items may be selected through a real-time auction hosted by the content serving platform. A content provider such as a merchant may provide a product catalog to the content serving platform. The product catalog could include millions of products available through the merchant, which may be displayed as content items to users by the content serving platform. The content serving platform may automatically create a personalized experience for a user accessing a website by choosing products from the product catalog that may be of interest to the user. The products may be used to generate content items that can be displayed through the website to the user. The content items that are selected to be presented to the user may be selected as part of the real-time auction. The real-time auction takes into account budget considerations and targeting considerations of the merchant and/or the products of the catalog. A product from the catalog with the highest bid is selected and provided as a content item to the user by the content serving platform.

Campaigns may be used by the content serving platform as part of the selection process. One type of campaign is a retargeting campaign. The retargeting campaign is used to serve users that already showed an interest in a content item at a content provider website (e.g., showed an interest in a particular video game by reading a description of the video game through a website of an online merchant). When the user visits a website supported by the content serving platform, the content item (e.g., a description and link to purchase the video game) may be displayed to the user as a retargeted content item. Another type of campaign is a prospecting campaign. The prospecting campaign has the goal of expanding an audience of a content provider by presenting content items to users that have not directly interacted with the content items. Various models (e.g., machine learning models) may be used to leverage additional signals such as search history and location of a user in order to predict what content items may be relevant and interesting to the user.

The techniques provided herein improve operation of the content serving platform by providing a conversion prospecting approach to provide dynamic product content items to users. Dynamic product content items may be used for e-commerce merchants. A merchant may provide a product catalog of products, which could include millions of products, to a content serving platform. The content serving platform may automatically create personalized content item experiences for users by choosing products from the catalogs. The products are used to dynamically generate the content items, which may depict a product, describe the product, recommend the product, link to a webpage or application so that users can perform actions such as purchase the product, etc. The content serving platform provides the content items through various campaigns such as a retargeting campaign and/or a prospecting campaign (e.g., a prospective campaign that utilizes conversion prospecting).

The content serving platform may include a click prediction model that predicts the probability that a certain user will click on a content item of a product. The content serving platform includes a database that stores products and campaign information that can be used to filter products such as campaign budgets, targeting considerations (e.g., a woman's top may be targeted to a particular audience), or other considerations. The campaign information can also be used to obtain a content provider's bid, fetch product assets for rendering a content item (e.g., an image, title, description, etc.), and/or perform other actions. The content serving platform may include various types of eligibility models used to identify products eligible for participating in an auction by the content serving platform for being provided to users, such as the disclosed model (a conversion-prospecting model) used for conversion prospecting. Other models may include retargeting models and other types of prospecting models that each have their own logic to decide which products are eligible as candidates to be presented to a user (e.g., products that may be relevant and/or interesting to a user that may purchase such products). The content serving platform includes a content serving platform that utilizes the click prediction model, the database, and the eligibility models for selecting and rendering content items of products, which may also compete in other auctions used to select and provide users with content items.

This innovation provides a conversion prospecting type model used by the content serving platform to identify eligible products. The conversion prospecting type model achieves a pre-calculated cost-per-action (CPA) goal where an action may relate to a post-click conversion, such as purchase of a product done by a user at a website of a content provider after the user has clicked on a content item recommending the product. The CPA goal is calculated by predicting a conversion rate, and is used to determine a user's eligibility to be shown a product and is used to optimize bids for auctions hosted by the content serving platform. The predictions may be provided by an event prediction algorithm (e.g., a feature enhanced collaborative filtering based event prediction algorithm or any other type of algorithm).

Conversion prospecting involves logging content item events including impressions (e.g., a user viewing a content item), clicks (e.g., a user clicking on a content item), and conversions (e.g., a user purchasing a product recommended by a content item). The event prediction algorithm is used to train a model to predict a conversion-given-click probability pCONV(u,p) of a user u and a product p. The event prediction algorithm receives inputs of batches of new positive events and new negative events (e.g., from a feed of the content serving platform, a simulation of events, etc.), and incrementally trains the model (a conversion-prospecting model) using the batches of positive events and negative events. Positive events may be post-click conversions such as where a user purchases a product after the user clicks on a content item recommending the product. Negative events may be where the user clicks the content item, but does not purchase the product.

Because clicks and conversions may not be joined due to conversion delays (e.g., a post-click conversion may arrive up to 30 days after the user has clicked the content item), the model may under predict because the model is trained on an additional negative event for each positive event. Thus, a final prediction is set/adjusted as P=P/(1−P′), where P′ is the “raw” prediction from the model, which compensates for the under prediction due to the model being trained on additional negative events.

For each incoming user and a context of the user, the model is used to calculate a bid for each product. The bid (a final bid) is calculated as Bid_final (u,p)=min{bid(p), pCONV(u,p)×tCPA(p)}, where bid(p) is a content provider's bid for a product p, pCONV(u,p) is a conversion-given-click probability of a user u and the product p, and tCPA(p) is a target cost per action (e.g., a product purchase). tCPA(p)=F×tCPA(p)_retargeting, where F−tCPA factor, where F is a positive factor (e.g., F=1.5 or any other value), and where tCPA(p)_retargeting is an average tCPA (e.g., spend divided by the number of conversions) of all products of the content provider of product p in retargeting campaign impressions through the content serving platform. The final bid is being set to (a) ensure that a user is eligible to a product if an expected value satisfies a content provider's target, and (b) the expected value is not exceeding what the content provider will pay for a click. An incoming user u to a webpage w is eligible for a product p (e.g., the user u may be eligible for the product p) if the final bid is larger than a floor price of w (e.g., set by the publisher), which is represented by Bid_final (u,p)>=floor_price (w).

In some embodiments, operation of the content serving platform is improved by bounding the model (e.g., a published version of the model after training) to K products (e.g., K=1000) that are selected by taking the top-K products with the highest amount of conversions and that exceeds a predefined minimal number of conversions (e.g., 10 conversions). Products participate in an internal auction using the final bids before continuing to a next stage (auction) of the content serving platform. This model provides a significant lift in audience for a content provider (e.g., a 10% delivery lift of content items), while maintaining the CPA within an acceptable range (e.g., defined with respect to the CPA of a retargeting audience expansion approach/campaign type). A performance goal is set as a percentage of spend that a content provider will accept such as where the CPA=(total spend)/(number of conversions) where conversion prospecting is set to be at most 1.5 times the targeting value. In some embodiments, the tCPA factor F is set to 1.5 or some other value, which may be set by a content provider or may be a calculated value. Since users are represented by their features, audience expansion is less restricted than other prospecting types that require a user id or bCookie.

Unlike other prospecting types, conversion prospecting expands an audience while maintaining a cost-per-action (CPA) performance goal. Conversion prospecting includes users that have already interacted with a content provider website in order to establish an adequate tCPA for operation. Performance goal conversion prospecting leverages data feeds of a content provider (e.g., a provider of a website, email, mobile app, news, e-commerce marketplace, etc.) to predict the probability that a user will convert on (e.g., purchase) a product after clicking on a content item recommending the product. This allows for granular target of select users such as users that are expected to meet a desired conversion goal, and bid optimization to ensure tCPA is achieved. Broader audience expansion is provided where a user's eligibility to products is determined based on user features and product features. Since user-identification (e.g., user id or bCookie) or location-based targeting is more limited in scope compared to targeting based on user characteristics, the potential reach of conversion prospecting is greater than other prospecting methods. The reach of users can be expanded or reduced by modifying the performance objective. In particular, the tCPA factor can be adjusted according to requirements of a content provider. A smaller tCPA factor will lead to a reduced bid and a smaller pool of eligible users. A larger tCPA factor will lead to an increased bid and a larger pool of eligible users

In some embodiments of implementing conversion prospecting, product events are logged, which may include impressions, clicks, and conversions. A model (a conversion-prospecting model) is trained to predict a conversion-given-click probability pCONV(u,p) of user u and product p. To determine the user's eligibility to a certain product, a performance goal (e.g., tCPA) of a content provider is obtained. If the performance goal is not explicitly specified, then the performance goal of a target CPA (tCPA) is set to 1.5 times a CPA for retargeting (a retargeting campaign) since content providers are willing to spend 50% more for new users (prospecting users that have not yet shopped with or access a website of a content provider) than for re-targeted users (e.g., users that have already shopped with or access the website). Hence, the target CPA (tCPA) is set to 1.5·CPA_retargeting. With this information, the content provider's bid (Bid_advertiser), and the calculated target CPA (tCPA), the final bid is determined. The final bid is set to a value to ensure that a user is eligible to a product if an expected value meets the target of the content provider, and that the expected value does not exceed what the content provider is willing to spend for a click. Accordingly, the final bid is set to Bid_final=min{pCONV(u,p)·tCPA(p), bid(p)}.

A user is eligible to all products for which the calculated bid value is above a webpage floor price. In contrast to other bidding strategies such as optimized cost-per-click (oCPC) that sets a bid based on a performance goal (e.g., advertisers'tCPA), the disclosure conversion prospecting uses a content provider's bid as an upper bound to the final bid.

The model (the conversion-prospecting model) is based on an event prediction algorithm. The event prediction algorithm gets as input mini-batches of new positive events and negative events, such as from a feed of the content serving platform, and incrementally trains the model. The inputs are post-click conversions of products (e.g., purchase of a product after the user clicked on a content item recommending the product) as positive events, and unconverted clicks as negative events. Due to the data sparsity of the events in the product level, the model may not be learning the full hierarchy of the product. Therefore, the model includes the following product features: product identifier; product set identifier; and advertiser identifier. On the user side, the model features are: (1) ctr-campaign-top as a multi-value feature holding a list of campaigns with the user's highest click through rate (CTR) during a timespan such as the last week; (2) dpa-type-experiment-id since there are many campaign types and experiments, where each of them performs differently; and (3) page-section is the webpage identifier where the user viewed the content item of the product. Since users are represented by their features, audience expansion is less restricted than those of other prospecting types such as search prospecting that require a user id or a bCookie.

Given a user u and a product p, the model predicts the probability that the user would convert on that product (e.g., purchase the product). Clicks and conversion events may not be combined due to long conversion delays. Therefore, the model under-predicts since the model trains on additional negative event for each positive event. Thus an adjusted/final prediction is set as P≈P\tilde{ }/(1−P\tilde{ }), where P\tilde{ } is the “raw” prediction.

After the training phase, the model is published as an input for the content serving platform's content serving flow. Due to serving limitations, the published model may be bounded to K (e.g., K=1000) products that are picked by taking the top-K products with the highest amount of conversions and that exceed a predefined minimal number of conversions (e.g., 10 conversions). This guarantees that the published model includes products that were trained on a significant amount of conversions. Moreover, the target cost-per-action (tCPA) of all selected products of each content provider (to be used in internal auctions and eventually in native auctions of the content serving platform) is set to 1.5·CPA_retargeting, where CPA_retargeting is the CPA measured for all products of each content provider when served as a retargeting campaign type.

Conversion prospecting content item serving may utilize eligibility models such as the conversion-prospecting model. When a new model is published such as the conversion prospecting model, products' vectors are indexed and their bids (bid(p)) and tCPA are fetched (for every content item product group). During serving time, for each incoming user u and user context (e.g., the webpage identifier of the webpage being visited by the incoming user), the serving system of the content serving platform uses the published model to predict the conversion-given-click probability pCONV(u,p) for every product p that is included in the published model and sets a final bid according to Bid_final=min{pCONV(u,p)·tCPA(p), bid(p)}. To decrease the load on the serving system, conversion prospecting products are competing in internal preliminary auctions with other conversion prospecting products. An internal auction is based on scores given for each product which is the final bid multiplied by the probability of a click. Only the top L (e.g., L=40) products continue to the next stage of processing by the content serving platform. This way, the model is used to identify eligible items for the next stage.

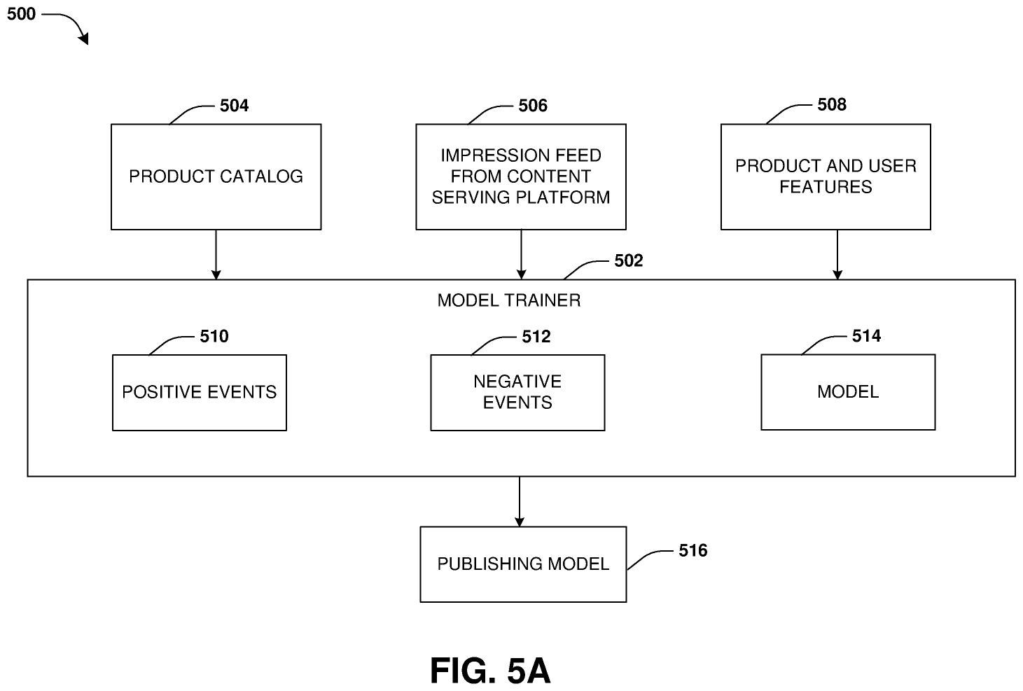

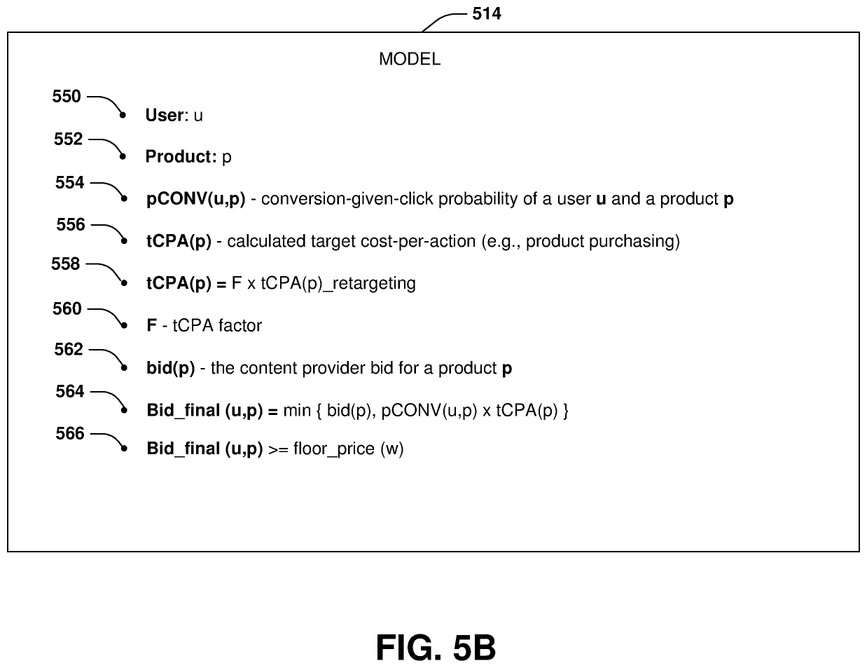

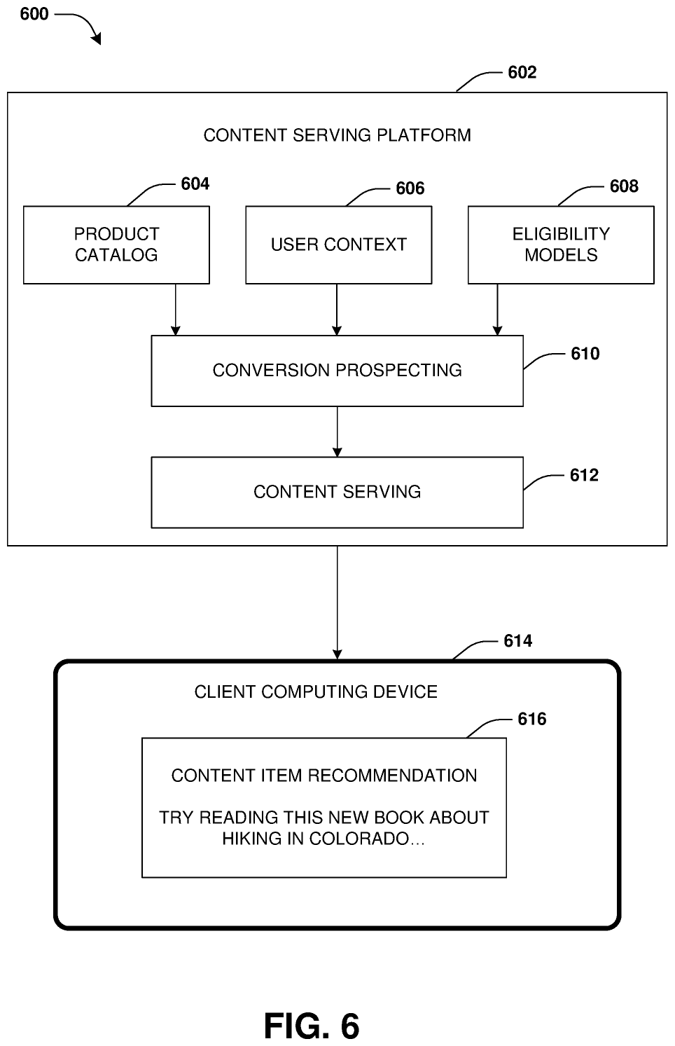

FIG. 4 is a flow chart illustrating an example method for providing conversion prospecting for dynamic content recommendation, which is described in conjunction with system 500 FIGS. 5A and 5B and system 600 of FIG. 6. During operation 402 of method 400, a model trainer 502 is configured to train a model 514 (a conversion-prospecting model) to predict conversion-given-click probabilities of users and products of a product catalog 504, as illustrated by FIG. 5A. The model trainer 502 trains the model 514 using positive events 510 and negative events 512, which may be obtained from an impression feed 506 of a content serving platform or may be obtained from another source or generated for training. A positive event may correspond to a user performing an action (e.g., purchasing a product) after interacting with a content item recommending the product. The negative event may correspond to a user interacting with a content item recommending a product without subsequently performing an action for the product.

The model 514 may represent products and users with product and user features 508. The model 514 may represent products of the product catalog 504 with product features that include product identifiers, product set identifiers, and/or content provider identifiers of content providers through which the products may be obtained or purchased. The model 514 may comprise a multi-value feature containing a list of content item campaigns with highest click through rates of a user during a time period (e.g., ctr-campaign-top as a multi-value feature holding a list of campaigns with the user's highest CTR during the last week). The model 514 may comprise a content serving platform experiment identifier (e.g., a dpa-type-experiment-id as there may be different campaign/serving types and experiments, where each performs differently). The model 514 may comprise a page section corresponding to a webpage identifier where a user viewed a content item of a product.

During training, predictions generated by the model 514 may be adjusted because the model 514 under predicts due to the model 514 being trained on an additional negative event for each positive event. Thus, an adjusted prediction is set as P=P/(1−P′), where P′ is the “raw” prediction. The model 514 may be bound by a set number of products (e.g., 1000 products or any other number). The set number of products may include products selected based upon the products having higher amounts of conversions than other non-selected products and based upon the products exceeding a predefined minimum number of conversions (e.g., 10 conversions or any other number). Once the model 514 is trained, the model trainer 502 publishes 516 the model 514 for use by a content serving platform in predicting conversion-given-click probabilities.

During operation 404 of method 400, the model 514 is utilized to generate a prediction of a conversion-given-click probability 554 that a user u 550 will perform an action in relation to product p 552, which may be generated as pCONV(u,p)−conversion-given-click probability of user a u and a product p, as illustrated by FIG. 5B. During operation 406 of method 400, the model 514 is used to generate a bid 564 (a final bid), which may be generated as Bid_final (u,p)=min{bid(p), pCONV(u,p)×tCPA(p)}. The bid 564 takes into account the conversion-given-click probability 554 pCONV(u,p), a content provider bid 562 for the product (p), and a target cost per action 556 tCPA(p). The target cost per action 556 tCPA(p) may take into account a factor F 560 (a tCPA factor) applied to CPA(p)_retargeting. A factor F 560 (e.g., F=1.5). The CPA(p)_retargeting corresponds to an average spend divided by a number of conversions of products of a content provider of the product p where the products are part of retargeting impressions (a retargeting campaign). Thus the target cost per action 556 is calculated 558 as tCPA(p)=F×CPA(p)_retargeting.

In some embodiments, the target cost per action 556 tCPA(p) may be reduced to reduce a value of the bid 564 and to decrease a pool of eligible users for the product p 552. In some embodiments, the target cost per action 556 tCPA(p) may be increased to increase the value of the bid 564 and to increase the pool of eligible users for the product p 552.

The bid 564 may be set to guarantee that the user u 550 is eligible for the product p 552 if an expected value satisfies a content provider target. The bid 564 may be set to guarantee that a value of the bid 564 does not exceed an amount the content provider will pay for a click.

During operation 408 of method 400, a determination is made based upon the bid 564 as to whether the product p 552 is to compete within auction(s) hosted by the content serving platform. In some embodiments, a calculation 566 is performed such that the user u 550 is eligible for the product p 552 and thus the product p 552 will compete in the auction(s) if the bid 564 exceeds a floor price w (e.g., the publisher's floor price w) of a webpage, Bid_final (u,p)>=floor_price (w).

During operation 410 of method 400, the content serving platform

performs auction(s) to select and transmit products to devices for display to users, an embodiment of which is illustrated by FIG. 6.

FIG. 6 illustrates a system 600 that includes a content serving platform 602. The content serving platform 602 utilizes a model (a conversion-prospecting model) to select and provide a content item to a computer device for display to a user. For example, the content serving platform 602 utilizes a click model, content item and campaign information of products within a product catalog 604, a user context 606 of the user (e.g., user features), and eligibility models 608 (e.g., a conversion-prospecting model such as model 514) for conversion prospecting 610 and content serving functionality 612.

When a user of a client computing device 614 accesses a website (or application) for which the content serving platform 602 is enabled, the content serving platform 602 receives contextual information (user context 606), such as user features about the user (e.g., age, gender features, browsing history, etc.) and features of the website being accessed by the client computing device 614 (e.g., in order to generate a content item with features that match website content, such as matching color and style). The conversion prospecting 610 utilizes the eligibility models 608 to process the user context 606 of the user and content item features from the content item and campaign information in order to determine whether the user is eligible to be provided with certain content items. The click model may be used to determine whether the user will click on the content items. Conversion prospecting 610 may utilize the conversion-prospecting model of the eligibility models 608 to generate a prediction of a conversion given a click probability that the user will perform an action in relation to a product, which is used to generate a bid for the product. The bid is used by the conversion prospecting 610 to determine whether the product is eligible to participate in auction(s) hosted by content serving functionality 612 of the content serving platform 602.

The content items, for which the eligibility models 608 have been used to determine that the user is eligible, are considered by content serving functionality 612 of the content serving platform 602 in order to select and provide one or more content items to the client computing device 614 for display to the user. The content serving functionality 612 may involve an auction that is performed where the content items bid on the opportunity to be provided to the client computing device 614. In an example, a content item recommendation 616 of a content item having a winning bid may be created by the content serving platform 602, and is provided to the client computing device 614 for display to the user.

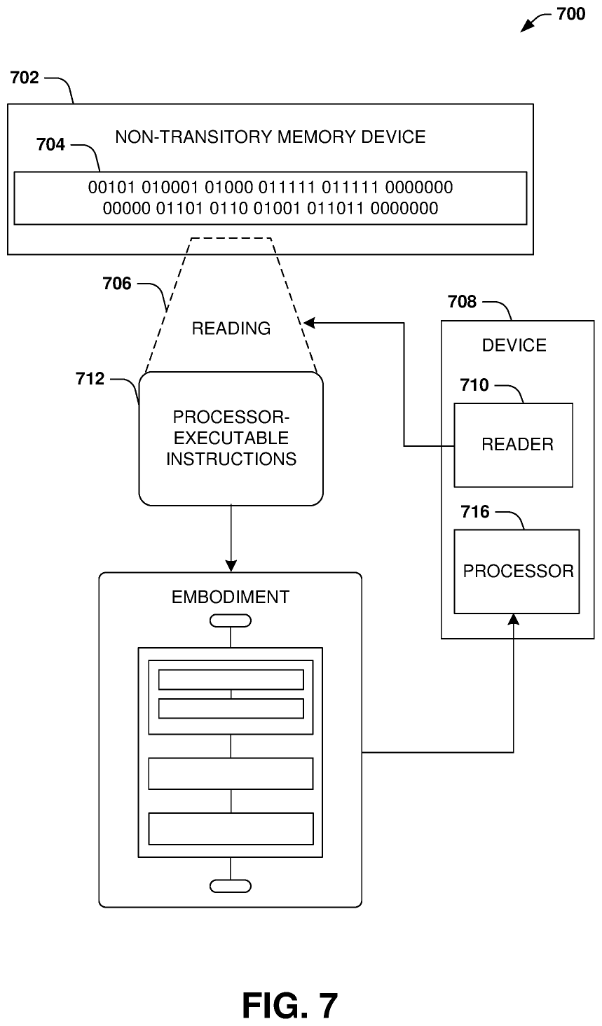

FIG. 7 is an illustration of a scenario 700 involving an example non-transitory machine readable medium 702. The non-transitory machine readable medium 702 may comprise processor-executable instructions 712 that when executed by a processor 716 cause performance (e.g., by the processor 716) of at least some of the provisions herein. The non-transitory machine readable medium 702 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 702 stores computer-readable data 704 that, when subjected to reading 706 by a reader 710 of a device 708 (e.g., a read head of a hard disk drive, or a read operation invoked on a solid-state storage device), express the processor-executable instructions 712. In some embodiments, the processor-executable instructions 712, when executed cause performance of operations, such as at least some of the example method 400 of FIG. 4, for example. In some embodiments, the processor-executable instructions 712 are configured to cause implementation of a system, such as at least some of the example system 500 of FIG. 5 and/or at least some of the example system 600 of FIGS. 6A-6C, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In some embodiments, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method executing on a processor of a computing device that causes the computing device to perform operations comprising:
training a model to predict conversion-given-click probabilities of users and products, where the training comprises incrementally training the model on sets of positive events and sets of negative events from a content serving platform;
generating, utilizing the model, a prediction of a conversion-given-click probability that a user will perform an action in relation to a product;
generating, utilizing the model, a bid for the user and the product based upon the conversion-given-click probability, a content provider bid for the product, and a target cost per action;
determining whether the product is to compete in an auction hosted by the content serving platform based upon the bid; and
transmitting content items of products selected by the content serving platform to devices for display to users.

2. The method of claim 1, wherein a positive event corresponds to a first user performing the action after interacting with a first content item, and wherein a negative event corresponds to the first user interacting with a second content item without subsequently performing the action.

3. The method of claim 1, wherein the model represents products with product features that include product identifiers, product set identifiers, and content provider identifiers.

4. The method of claim 1, wherein the model comprises a multi-value feature containing a list of content item campaigns with a highest click through rate of a first user during a time period.

5. The method of claim 1, wherein the model comprises a content serving platform experiment identifier.

6. The method of claim 1, wherein the model comprises a page section corresponding to a webpage identifier where a user viewed a content item.

7. The method of claim 1, comprising:
adjusting, during training of the model, predictions generated by the model based upon the model under-predicting due to the model being trained on an additional negative event for each positive event.

8. The method of claim 1, comprising:
calculating the target cost per action by applying a factor to an average spend divided by a number of conversions of products of a content provider of the product, wherein the products are part of retargeting impressions.

9. The method of claim 1, comprising:
setting the bid to guarantee that the user is eligible for the product if an expected value satisfies a content provider target.

10. The method of claim 1, comprising:
setting the bid to guarantee that a value of the bid does not exceed an amount the content provider will pay for a click.

11. The method of claim 1, comprising:
determining that the user is eligible for the product based upon the bid exceeding a floor price.

12. A non-transitory machine readable medium having stored thereon processor-executable instructions that when executed cause performance of operations, the operations comprising:
training a model to predict conversion-given-click probabilities of users and products, where the training comprises incrementally training the model on sets of positive events and sets of negative events from a content serving platform;
generating, utilizing the model, a prediction of a conversion-given-click probability that a user will perform an action in relation to a product;
generating, utilizing the model, a bid for the user and the product based upon the conversion-given-click probability, a content provider bid for the product, and a target cost per action;
determining whether the product is to compete in an auction hosted by the content serving platform based upon the bid; and
transmitting content items of products selected by the content serving platform to devices for display to users.

13. The non-transitory machine readable medium of claim 12, wherein the operations comprise:
bounding the model by a set number of products selected to include products having higher amounts of conversions than other products and that exceed a predefined minimum number of conversions.

14. The non-transitory machine readable medium of claim 12, wherein the operations comprise:
reducing the target cost per action to reduce a value of the bid and to decrease a pool of eligible users for the product.

15. The non-transitory machine readable medium of claim 12, wherein the operations comprise:
increasing the target cost per action to increase the value of the bid and to increase a pool of eligible users for the product.

16. A computing device comprising:
a processor; and
memory comprising processor-executable instructions that when executed by the processor cause performance of operations, the operations comprising:
training a model to predict conversion-given-click probabilities of users and products, where the training comprises incrementally training the model on sets of positive events and sets of negative events from a content serving platform;
generating, utilizing the model, a prediction of a conversion-given-click probability that a user will perform an action in relation to a product;
generating, utilizing the model, a bid for the user and the product based upon the conversion-given-click probability, a content provider bid for the product, and a target cost per action;
determining whether the product is to compete in an auction hosted by the content serving platform based upon the bid; and
transmitting content items of products selected by the content serving platform to devices for display to users.

17. The computing device of claim 16, wherein the operations comprise:
bounding the model by a set number of products selected to include products having higher amounts of conversions than other products and that exceed a predefined minimum number of conversions.

18. The computing device of claim 16, wherein the operations comprise:
reducing the target cost per action to reduce a value of the bid and to decrease a pool of eligible users for the product.

19. The computing device of claim 16, wherein the operations comprise:
increasing the target cost per action to increase a value of the bid and to increase a pool of eligible users for the product.

20. The computing device of claim 16, wherein the operations comprise:
calculating the target cost per action by applying a factor to an average spend divided by a number of conversions of products of a content provider of the product.
